(19) United States
(12) Patent Application Publication
(10) Pub. No.: US 2016/0000293 A1
(43) Pub. Date: Jan. 7, 2016

(54) METHOD, DEVICE, KIT AND COMPOSITION FOR REMOVING GROUT HAZE FROM TILES

(71) Applicant: Cary POVITZ, Montréal, (CA)

(72) Inventor: Cary POVITZ, Montréal (CA)

(21) Appl. No.: 14/768,760

(22) PCT Filed: Mar. 3, 2014
(86) PCT No.: PCT/CA2014/000165

§ 371 Date: Aug. 18, 2015

Related U.S. Application Data
(60) Provisional application No. 61/771,426, filed on Mar. 1, 2013.

(51) Int. Cl. A47L 13/19; C11D 11/00; C11D 7/12; A47L 13/17; C11D 7/44

(52) U.S. Cl. CPC A47L 13/19; A47L 13/17; C11D 7/44; C11D 7/12; C11D 11/0052

(57) ABSTRACT

A method of removing grout haze from a tile surface includes a composition in powder form is provided, the composition includes between 90% to 97% of Zea Mays and between 3% to 10% of a mixture comprising Sodium Bicarbonate and Calcium Carbonate, The composition is applied on the tile surface having the grout haze. The tile surface is then scrubbed. A method of tiling a surface includes the foregoing method of removing the grout haze from the tiles. A kit Includes a device such as an applicator for containing the composition. The applicator is used to scrub the tile surface and provides for the composition to be disbursed therefrom.

### CROSS-REFERENCE TO RELATED APPLICATIONS

The present application claims priority on United States Provisional Application No. 61/771,426 filed on Mar. 1, 2013 and incorporated herein by reference in its entirety.

### TECHNICAL FIELD

The present disclosure generally relates to tiling. More particularly, but not exclusively, the present disclosure relates to a method, a device, a kit and a composition for removing grout haze from tiling. Still more particularly, but not exclusively, the present disclosure relates to a method of tiling.

### BACKGROUND

Tiling is a popular process using a manufactured piece of hard-wearing material such as ceramic, stone, metal, glass and the like to cover a surface such as roofs, floors, walls, showers, tabletops and the like. The tiles are positioned side by side, sometimes with interlocking tongues and grooves. The spaces between the tiles are grouted. Various types of grout (or mortar) are widely used. Grout is generally composed of a mixture of water, cement, sand, often color tint, and sometimes fine gravel. It is applied as a thick emulsion and hardens over time. Some varieties of tiling grout include urethane, cement-based, epoxy, flooring grout, resin grout, non-shrink grout, structural grout and thixotropic grout.

Grout haze is a film of excess grout left on a tile as a result of a fresh grout application and disrupts the aesthetic façade of the surfaces. New tile floors or freshly grouted tile walls will often suffer from grout haze as it is extremely difficult to prevent.

There exist a variety of chemical based solutions for removing grout haze from tiles. Drawbacks of such processes are that they are often toxic and ruin the façade of the tile.

There thus remains a need for an improved method of removing grout haze from tile surfaces

### OBJECTS

An object of the present disclosure is to provide a method for removing grout haze from a tile surface.

An object of the present disclosure is to provide a method of tiling a surface.

An object of the present disclosure is to provide a device for removing grout haze from a tile surface.

An object of the present disclosure is to provide a kit for removing grout haze from a tile surface.

An object of the present disclosure is to provide a composition for removing grout haze from a tile surface.

### SUMMARY

In accordance with an aspect of the disclosure, there is provided a method for removing grout haze from a tile surface, the method comprising: providing a composition in powder form, the composition comprising between 90% to 97% of Zea Mays and between 3% to 10% of a mixture comprising Sodium Bicarbonate and Calcium Carbonate; applying the composition on the tile surface having the grout haze; scrubbing the tile surface on which the composition was applied to; and cleaning the tile surface after scrubbing to remove excess composition residue.

In an embodiment of the method for removing grout haze from a tile surface, the mixture comprises a greater amount of Sodium Bicarbonate than Calcium Bicarbonate. In an embodiment of the method for removing grout haze from a tile surface, the composition comprises 95% of Zea Mays. In an embodiment of the method for removing grout haze from a tile surface, the composition comprises between 3% to 5% Sodium Bicarbonate. In an embodiment of the method for removing grout haze from a tile surface, the composition comprises between 0.25% to 1% of Calcium Bicarbonate. In an embodiment of the method for removing grout haze from a tile surface, the mixture comprises 4.5% of Sodium Bicarbonate and 0.5% of Calcium Carbonate.

In accordance with an aspect of the disclosure, there is provided a method of tiling a surface comprising: applying tiles on the surface; applying grout between the tiles; allowing for the grout to settle; and removing any grout haze that has accidentally landed on the tile surface during grout application, wherein removing the grout comprises: providing a composition in powder form, the composition comprising between Zea Mays and between 90%-97% and between 3% to 10% of a mixture comprising Sodium Bicarbonate and Calcium Carbonate; applying the composition on the tile surface having the grout haze; scrubbing the tile surface on which the composition was applied to; cleaning the tile surface after scrubbing to remove excess composition residue.

In an embodiment of the method of tiling a surface, the mixture comprises a greater amount of Sodium Bicarbonate than Calcium Bicarbonate. In an embodiment of the method of tiling a surface, the composition comprises 95% of Zea Mays. In an embodiment of the method of tiling a surface, the composition comprises between 3% to 5% of Sodium Bicarbonate. In an embodiment of the method of tiling a surface, the composition comprises between 0.25% to 1% of Calcium Bicarbonate. In an embodiment of the method of tiling a surface, the mixture comprises 4.5% of Sodium Bicarbonate and 0.5% Calcium Carbonate.

In accordance with an aspect of the disclosure, there is provided a device for removing grout haze from a tile surface, the device comprising: a first sheet of porous material; a second sheet of material overlaying the first sheet of porous material and being sealed therewith about their respective peripheral edges thereby defining a container space therebetween, the second sheet defining an outer surface comprising a hand receiving portion; and a composition In powder form within the container space comprising between 90%-97% of Zea Mays and between 3% to 10% of a mixture comprising Sodium Bicarbonate and Calcium Carbonate, wherein the first sheet of porous material provides for the composition in the container space to be disbursed therefrom.

The terms “first” and “second are used herein for indicative purposes only and thus are interchangeable.

In an embodiment of the device, the mixture comprises a greater amount of Sodium Bicarbonate than Calcium Bicarbonate. In an embodiment of the device, the composition comprises 95% of Zea Mays. In an embodiment of the device, the composition comprises between 3% to 5% of Sodium Bicarbonate. In an embodiment of the device, the composition comprises between 0.25% to 1% of Calcium Bicarbonate. In an embodiment of the device, the mixture comprises 4.5% of Sodium Bicarbonate and 0.5% Calcium Carbonate. In an embodiment of the device, the respective peripheral edges comprise an edge opening that is selectively sealable providing for adding or removing the composition therefrom.

In accordance with an aspect of the disclosure, there is provided a kit for removing grout haze from a tile surface, the kit comprising: a composition in powder form comprising between 90%-97% of Zea Mays and between 3% to 10% of a mixture comprising Sodium Bicarbonate and Calcium Carbonate; an applicator for being filled with the composition and sealed, the applicator comprising an applying surface side for providing for the composition to be disbursed therefrom on the tile surface during scrubbing of the tile surface therewith.

In an embodiment of the kit, the mixture comprises a greater amount of Sodium Bicarbonate than Calcium Bicarbonate. In an embodiment of the kit, the composition comprises 95% of Zea Mays. In an embodiment of the kit, the composition comprises between 3% to 5% of Sodium Bicarbonate. In an embodiment of the kit, the composition comprises between 0.25% to 1% of Calcium Bicarbonate. In an embodiment of the kit, the mixture comprises 4.5% of Sodium Bicarbonate and 0.5% of Calcium Carbonate. In an embodiment of the kit, the applicator comprises hand receiving portion on a side opposite the applying surface side. In an embodiment of the kit, the applying surface side is porous for allowing the composition to be disbursed therefrom. In an embodiment of the kit, the applying surface side comprises perforations for allowing the composition to be disbursed therefrom. In an embodiment of the kit, the kit further comprising a bag mounted within the applicator, the bag containing the composition, the bag being removable from the applicator for emptying the contents thereof within the applicator.

In accordance with an aspect of the disclosure, there is provided a composition for removing grout haze from a tile surface comprising between 90%-97% of Zea Mays in powder form and between 3% to 10% of a mixture comprising Sodium Bicarbonate in powder form and Calcium Carbonate in powder form.

In an embodiment of the composition, the mixture comprises a greater amount of Sodium Bicarbonate than Calcium Bicarbonate. In an embodiment, the composition comprises 95% of Zea Mays. In an embodiment of the composition, the mixture comprises between 3% to 5% of Sodium Bicarbonate. In an embodiment of the composition, the mixture comprises 0.25% to 1% of Calcium Bicarbonate. In an embodiment of the composition, the mixture comprises 4.5% of Sodium Bicarbonate and 0.5% of Calcium Carbonate.

Other objects, advantages and features of the present disclosure will become more apparent upon reading of the following non-restrictive description of Illustrative embodiments thereof, given by way of example only with reference to the accompanying drawings.

### BRIEF DESCRIPTION OF THE DRAWINGS

In the appended drawings:

FIG. 1 is a top perspective view of the applicator used in the present method and kit in accordance with a non-restrictive illustrative embodiment of the present disclosure;

FIG. 2 is an underside perspective view of the applicator of FIG. 1;

FIG. 3 is a front perspective view of the container used in the present method and kit in accordance with a non-restrictive illustrative embodiment of the present disclosure;

FIG. 4 is perspective view of the container being used to fill the applicator;

FIG. 5 is a top view of a device for removing grout haze from a tile surface in accordance with a non-restrictive illustrative embodiment of the present disclosure; and

FIG. 6 is a bottom view of the device of FIG. 5.

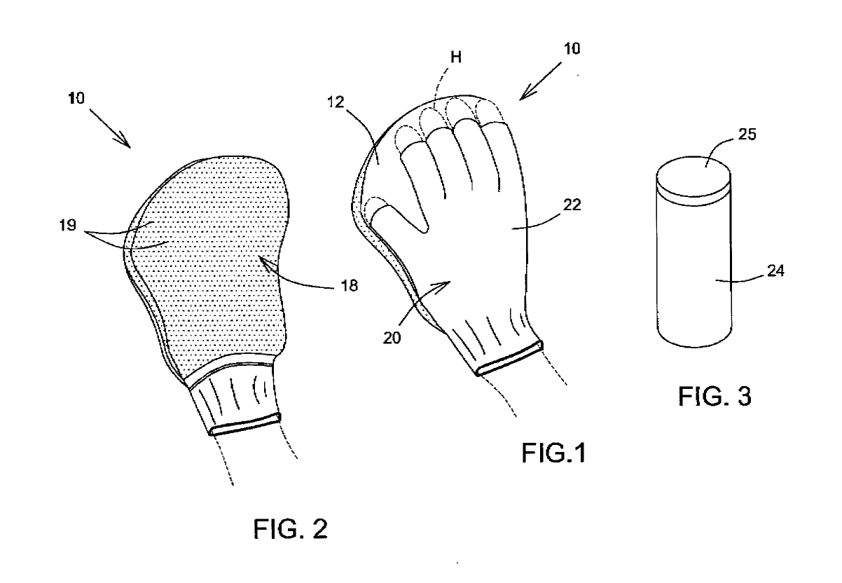

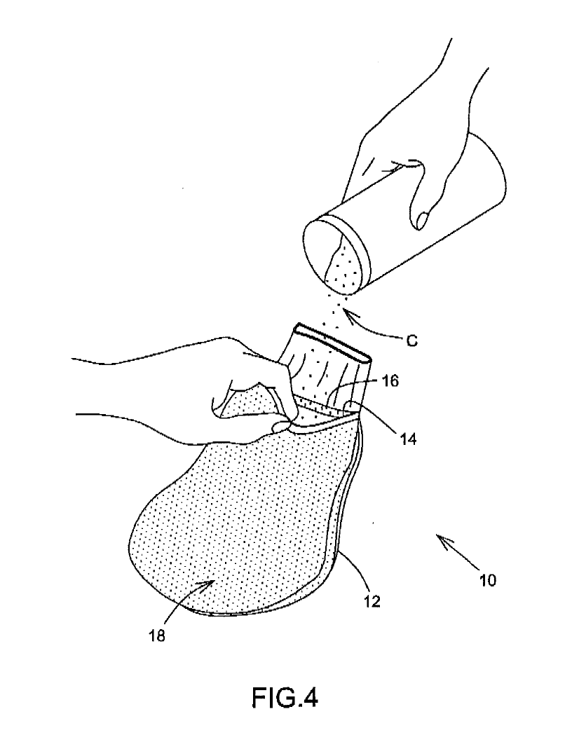

### DETAILED DESCRIPTION OF ILLUSTRATIVE EMBODIMENTS

Generally stated and in accordance with a non-limiting illustrative embodiment, there is provided A method of removing grout haze from a tile surface includes a composition in powder form is provided, the composition includes between 90% to 97% of Zea Mays and between 3% to 10% of a mixture comprising Sodium Bicarbonate and Calcium Carbonate. The composition is applied on the tile surface having the grout haze. The tile surface is then scrubbed. A method of tiling a surface includes the foregoing method of removing the grout haze from the tiles. A kit includes a device such as an applicator for containing the composition. The applicator is used to scrub the tile surface and provides for the composition to be disbursed therefrom.

With reference, to the appended Figures, non-restrictive illustrative embodiments will be herein described so as to further exemplify the disclosure only and by no means limit the scope thereof.

In an embodiment, there is provided a method of tiling comprising mounting tiles such as ceramic and porcelain tiles; or natural stones such as marble and granite on a surface. As is known in the art, grout is added between the spaces of the tile.

When grout haze lands on the surface of the tile, there is provided a method of removing the grout haze. The method comprises providing a composition to be applied on the tile surface including the grout haze.

The composition comprises between 90% to 97% of Zea Mays (Corn Starch) and between 3% to 7% of a mixture of Sodium Bicarbonate (Baking Soda) and Calcium Carbonate. In an embodiment of the composition, the mixture comprises a greater amount of Sodium Bicarbonate than Calcium Bicarbonate. In an embodiment, the composition comprises 95% of Zea Mays. In an embodiment of the composition, the mixture comprises 4.5% of Sodium Bicarbonate and 0,5% Calcium Carbonate. In an embodiment of the composition, the mixture comprises between 3% to 5% of Sodium Bicarbonate. In an embodiment of the composition, the mixture comprises 0.25% to 1% of Calcium Bicarbonate. In an embodiment, the composition comprises 95% of Zea Mays, 4,5% of Sodium Bicarbonate and 0.5% of Calcium Carbonate. In an embodiment, the composition is in powder form.

In an embodiment, a convenient time to clean up the grout haze is about twenty-four hours after the grout has set. In an embodiment, the work area is well-ventilated during application of the composition. In an embodiment, it is advisable to wear a mask in order to avoid excessive inhalation of powder. In an embodiment, it is convenient for the user to wear rubber gloves for additional protection while scrubbing. In an embodiment, It is convenient, prior to application, to test in a small inconspicuous area of the subject surface to determine ease of use and desired results.

Prior to applying the composition, the residual grout should be removed according to the grout manufacturer's instructions.

With reference to the Figures, there is shown an applicator 10. The applicator 10 comprises a main container body 12, shown in a bag form, having an edge 14 that can be can be selectively opened and sealed via adhesive strips 16 extending from the edge 14. The adhesive strips 16 are pushed together and bonded to seal the bag 12 and can be pulled apart to open the bag 12 in order to fill it with the composition C described herein via the edge opening 14. The applicator 10 includes an applying side 16 with perforations 19 and an opposite side 20 having a hand-receiving or mitt portion 22 for receiving a user's hand H.

The applicator can be provided in a variety of suitable configurations, including a bag, a mitt, a cloth within an internal containing compartment and the like to give but a few examples within the scope of the present disclosure.

The applicator 10 is filled with the composition from container 24 including a closure 25 containing this composition. The container can be in the form of a bag, a tube, a sack, a box or any other suitable enclosure as will be easily understood by the skilled artisan.

After filling the container bag 12 and mounting the mitt 22 on the hand of the user, the composition C can be disbursed out of the applying side 18 by impacting this side 18, by way of clapping using the alternate hand for example.

Gout haze will build up on the applying side 18 after scrubbing a large enough area. In one example, a large enough area comprises between approximately 20 sq. ft to 30 sq. ft., depending on the intensity of the force the user applies on the tile during scrubbing. The grout haze build up should be removed from the applying side 18 periodically by impacting this side 18 (clapping for example) thereby allowing more powder to desires from the side 18.

In one non-limiting example, an amount of 4 ½ oz of the composition in powder form can be used to clean a surface area of at least 1,500 sq ft. with regular scrubbing intensity.

After scrubbing the subject surface, any excess disbursed power should be removed, by vacuum for example. A dry cloth provides for wiping the subject surface after scrubbing. If the cloth accumulates powder residue it should be replaced.

Once the grout haze has been removed from the tiles surface, It is convenient in an embodiment, to follow up the foregoing with an application of grout sealer to seal and finish the grout on the tile job.

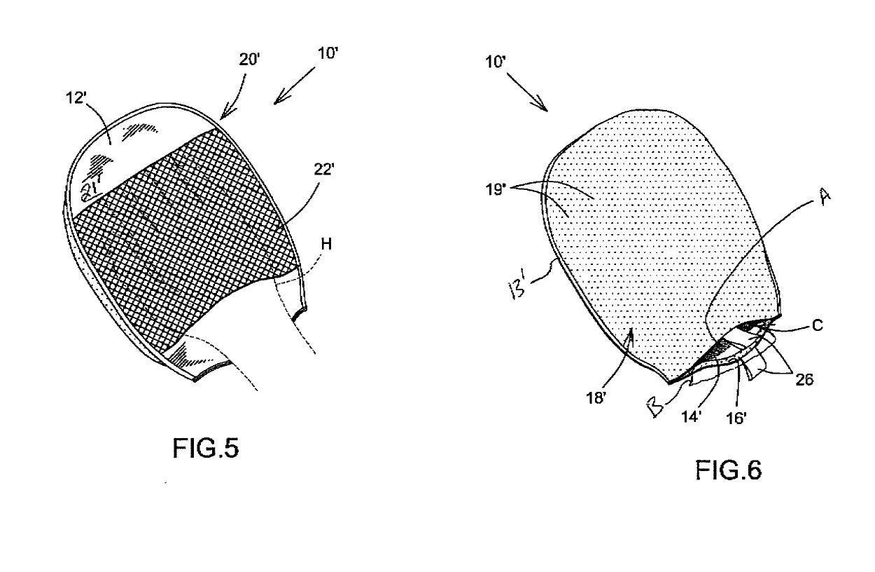

Turning now to FIGS. 5 and 6, there is shown a device 10′ that is similar to the applicator 10. The device 10′ is formed by a pair of overlying sheets of material 18′ and 20′ that form the main body 12′ of the device 10′. The sheets of material 18′ and 20′ are sealed at their respective peripheral edges which together define the peripheral edge 13′ of the device 10′. The pair of sheets 18′ and 20′ define a container space A therebetween for containing the composition C.

In an embodiment, the composition C is contained within a bag B that is contained within the space A for being removed therefrom and having its contents emptied into the space A.

Sheet 18′ is made of porous material and thus includes perforations 19′ for providing the composition C to be disbursed therefrom.

Sheet 20′ defines an outer side 21′ that includes a hand receiving portion 22′ such as a net for receiving the hand H of a user.

The edge 13′ includes a sealable opening 14′ for filling or emptying the device 10′ of the composition C or removing and/or adding bags B. The opening can be sealed via adhesive strips 16′ by pulling on straps 26′.

The present disclosure provides several non-limiting advantages, some of which are discussed herein. For example, it avoids using toxic chemicals in favor of organic substances and as such is safer to use and environmentally friendlier. It is efficient from a cost, time and labor point of view as it reduces overall installation time. It avoids the use of water or other harsh liquids.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or , described and thus partial combinations of features can also be contemplated. Furthermore, embodiments with less features than those described can also be contemplated. It is to be understood that the present disclosure is not limited in its application to the details of construction and parts illustrated In the accompanying drawings and described hereinabove. The disclosure is capable of other embodiments and of being practiced in various ways. It is also to be understood that the phraseology or terminology used herein is for the purpose of description and not limitation.

Hence, although the present disclosure has been provided hereinabove by way of non-restrictive illustrative embodiments thereof, It can be modified, without departing from the scope, spirit and nature thereof and of the appended claims.

1. A method for removing grout haze from a tile surface, the method comprising:
providing a composition in powder form, the composition comprising between 90% to 97% of Zea Mays and between 3% to 10% of a mixture comprising Sodium Bicarbonate and Calcium Carbonate;
applying the composition on the tile surface having the grout haze;
scrubbing the tile surface on which the composition was applied to; and
cleaning the tile surface after scrubbing to remove excess composition residue.

2. A method according to clam 1, wherein the mixture comprises a greater amount of Sodium Bicarbonate than Calcium Bicarbonate.

3. A method according to claim 1, wherein the composition comprises 95% of Zea Mays.

4. A method according to claim 1, wherein the composition comprises between 3% to 5% Sodium Bicarbonate.

5. A method according to claim 1, wherein the composition comprises between 0.25% to 1% of Calcium Bicarbonate.

6. A method according to claim 1, wherein the mixture comprises 4.5% of Sodium Bicarbonate and 0.5% of Calcium Carbonate.

7-19. (canceled)

20. A kit for removing grout haze from a tile surface, the kit comprising:
a composition in powder form comprising between 90%-97% of Zea Mays and between 3% to 10% of a mixture comprising Sodium Bicarbonate and Calcium Carbonate;
an applicator for being filled with the composition and sealed, the applicator comprising an applying surface side for providing for the composition to be disbursed therefrom on the tile surface during scrubbing of the tile surface therewith.

21. A kit according to clam 20, wherein the mixture comprises a greater amount of Sodium Bicarbonate than Calcium Bicarbonate.

22. A kit according to claim 20, wherein the composition comprises 95% of Zea Mays.

23. A kit according to claim 20, wherein the composition comprises between 3% to 5% of Sodium Bicarbonate.

24. A kit according to claim 13, wherein the composition comprises between 0.25% to 1% of Calcium Bicarbonate.

25. A kit according to claim 20, wherein the mixture comprises 4.5% of Sodium Bicarbonate and 0.5% of Calcium Carbonate.

26. A kit according to claim 20, wherein the applicator comprises hand receiving portion on a side opposite the applying surface side.

27. A kit according to claim 20, wherein the applying surface side is porous for allowing the composition to he disbursed therefrom.

28. A kit according to claim 20, wherein the applying surface side comprises perforations for allowing the composition to he disbursed therefrom.

29. A kit according to claim 20, further comprising a hag mounted within the applicator, the bag containing the composition, the bag being removable from the applicator for emptying the contents thereof within the applicator.

30. A composition for removing grout haze from a tile surface comprising between 90%-97% of Zea Mays in powder form and between 3% to 10% of a mixture comprising Sodium Bicarbonate in powder form and Calcium Carbonate in powder form.

31. A composition according to clam 30, wherein the mixture comprises a greater amount of Sodium Bicarbonate than Calcium Bicarbonate.

32. A composition according to claim 30, comprising 95% of Zea Mays.

33. A composition according to claim 30, wherein the mixture comprises between 3% to 5% of Sodium Bicarbonate.

34. A composition according to claim 30, wherein the mixture comprises 0.25% to 1% of Calcium Bicarbonate.

35. A composition according to claim 30, wherein the mixture comprises 4.5% of Sodium Bicarbonate and 0.5% of Calcium Carbonate.
